(19) United States
(12) Patent Application Publication
(10) Pub. No.: US 2024/0387823 A1
(43) Pub. Date: Nov. 21, 2024

(54) CATHODE ACTIVE MATERIAL COMPOSITE PARTICLES, CATHODE COMPOSITE MATERIAL, LITHIUM-ION BATTERY, AND PRODUCTION METHOD OF CATHODE ACTIVE MATERIAL COMPOSITE PARTICLES

(71) Applicant: TOYOTA JIDOSHA KABUSHIKI KAISHA, Toyota-shi (JP)

(72) Inventor: Azusa NAKANISHI, Susono-shi (JP)

(73) Assignee: TOYOTA JIDOSHA KABUSHIKI KAISHA, Toyota-shi (JP)

(21) Appl. No.: 18/433,623

(22) Filed: Feb. 6, 2024

(30) Foreign Application Priority Data
May 16, 2023 (JP) 2023-080801

(51) Int. Cl. H01M 4/60; H01M 4/02; H01M 4/36; H01M 4/62; H01M 10/0525

(52) U.S. Cl. CPC H01M 4/60; H01M 4/362; H01M 4/621; H01M 10/0525; H01M 2004/028

(57) ABSTRACT

The cathode active material composite particles of the present disclosure include surface-modified cathode active material particles and a binder resin. In addition, the surface-modified cathode active material particles included in the cathode active material composite particles of the present disclosure have a silicon particle and an organic group that modifies the surface of the silicon particle. The ratio of the mass of the binder resin contained in the cathode active material composite particles of the present disclosure to the total mass of the surface-modified cathode active material particles and the binder resin is 15% by mass or less.

### CROSS-REFERENCE TO RELATED APPLICATION

This application claims priority to Japanese Patent Application No. 2023-080801 filed on May 16, 2023, incorporated herein by reference in its entirety.

### BACKGROUND

### 1. Technical Field

The present disclosure relates to cathode active material composite particles, a cathode composite material, a lithium-ion battery, and a production method of the cathode active material composite particles.

### 2. Description of Related Art

In recent years, development of batteries has been actively promoted, for example, in the automotive industry, batteries used for battery electric vehicles and hybrid electric vehicles have been developed, and also, silicon is known as a cathode active material used for batteries.

Japanese Unexamined Patent Application Publication No. 2019-021571 (JP 2019-021571 A) discloses a cathode active material for an all-solid-state battery that includes cathode active material particles which are composites of silicon and carbon, and a binder, in which the cathode active material is granulated particles having a median diameter (D50) of 25 μm or less.

### SUMMARY

In composite particles including silicon particles and a binder resin, improvement of cycle properties is desired.

An object of the present disclosure is to provide cathode active material composite particles including silicon particles and a binder resin and having high cycle properties, a cathode composite material including such cathode active material composite particles, a lithium-ion battery including such cathode active material composite particles, and a production method of such cathode active material composite particles.

The disclosers have found that the above problem can be solved by the following means.

### First Aspect

Cathode active material composite particles, including surface-modified cathode active material particles, and a binder resin, in which the surface-modified cathode active material particles include silicon particles and an organic group modifying surfaces of the silicon particles, and a proportion of mass of the binder resin, as to a total mass of the surface-modified cathode active material particles and the binder resin, is 15% by mass or less.

### Second Aspect

The cathode active material composite particles according to the first aspect, in which the organic group is an alkyl group.

### Third Aspect

The cathode active material composite particles according to the second aspect, in which the alkyl group includes no less than five and no more than 20 carbon atoms.

### Fourth Aspect

The cathode active material composite particles according to the second aspect, in which the surface-modified cathode active material particles include a silicon-carbon bond, the silicon is silicon of the silicon particles, and the carbon is carbon of the alkyl group.

### Fifth Aspect

A cathode composite material, including the cathode active material composite particles according to the first aspect.

### Sixth Aspect

A lithium-ion battery, including a cathode active material layer, in which the cathode active material layer contains the cathode composite material according to the fifth aspect.

### Seventh Aspect

A production method of cathode active material composite particles, the production method including
(a) modifying surfaces of silicon particles with an organic group to obtain surface-modified cathode active material particles,
(b) forming droplets of a slurry containing the surface-modified cathode active material particles, a binder resin, and a solvent, to obtain slurry droplets, and
(c) performing airborne drying of the slurry droplets in a heated gas.

### Eighth Aspect

The production method according to the seventh aspect, in which in step (a), the surfaces of the silicon particles are modified with the organic group by hydrosilylation reaction, in which the organic group is added to a hydrosilyl group on the surfaces of the silicon particles.

According to the present disclosure, there can be provided cathode active material composite particles including silicon particles and a binder resin and having high cycle properties, a cathode composite material including such cathode active material composite particles, a lithium-ion battery including such cathode active material composite particles, and a production method of such cathode active material composite particles.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Cathode Active Material Composite Particles

The cathode active material composite particles of the present disclosure include surface-modified cathode active material particles and a binder resin. In addition, the surface-modified cathode active material particles included in the cathode active material composite particles of the present disclosure have a silicon particle and an organic group that modifies the surface of the silicon particle. The ratio of the mass of the binder resin contained in the cathode active material composite particles of the present disclosure to the total mass of the surface-modified cathode active material particles and the binder resin is 15% by mass or less.

The inventors of the present disclosure considered that one of the reasons why the cycle characteristics of the composite particles containing the silicon particles and the binder resin are low is that the silicon particles tend to aggregate in the composite particles. Specifically, although this is not intended to be bound by any theory, it is considered that when the silicon particles aggregate in the composite particles, the silicon particles cannot sufficiently contact the binder resin, and cracks or the like occur in the composite particles, thereby deteriorating the cycle characteristics.

On the other hand, the inventors of the present disclosure have found that in composite particles containing silicon particles and a binder resin, the cycle characteristics of the composite particles can be enhanced by modifying the surface of the silicon particles with an organic group, in particular, an alkyl group, and reducing the amount of the binder resin.

The reason for this is not intended to be bound by any theory, but is presumed as follows: That is, by modifying the surface of the silicon particles with an organic group, particularly an alkyl group, the dispersibility of the silicon particles in the composite particles is improved, and even when the amount of the binder resin in the composite particles is reduced to a certain level or less, it is considered that the binder resin can be appropriately disposed inside the composite particles. As described above, when the ratio of the binder resin in the composite particles is equal to or less than a certain value, the resistance of the composite particles as a whole is reduced, and therefore, it is considered that the cycle characteristics are improved.

Further, the silicon particles and the binder resin are sufficiently in contact with each other, the aggregation of the silicon particles in the composite particles is suppressed, an appropriate gap is formed between the silicon particles, the volume change when the silicon particles expand during charging and discharging can be relaxed by the gap, cracking or the like of the composite particles is suppressed, it is considered that the cycle characteristics are improved.

In the present disclosure, it is possible to confirm whether or not the cathode active material composite particles are appropriately prepared according to the size of variation in particle size. That is, as an indicator of the variation in the particle size, the value of (D90−D10)/D50 can be used, this value is less than 4.0, 3.5 or less, 3.0 or less, 2.5 or less, or 2.0 or less, it can be determined that the cathode active material composite particles are appropriately adjusted.

### Surface-Modified Cathode Active Material Particles

The cathode active material composite particles of the present disclosure include surface-modified cathode active material particles and a binder resin. Silicon Particle

The surface-modified cathode active material particles include silicon particles.

The composition of the silicon particles is not particularly limited. The ratio of the silicon element to all the elements included in the silicon particles may be, for example, not less than 50 mol %, not less than 70 mol %, or not less than 90 mol %.

In addition to Si element, the silicon-particle may contain another element such as a Li element. Other elements include Li elements, Sn elements, Fe elements, Co elements, Ni elements, Ti elements, Cr elements, B elements, and P elements.

The silicon particles may contain impurities such as oxides.

The silicon particles may be amorphous or crystalline. The crystalline phase contained in the silicon particles is not particularly limited.

The shape and size of the silicon particles are not particularly limited. The mean particle diameter of the silicon particles may be, for example, 30 nm or more, 50 nm or more, 100 nm or more, or 150 nm or more, and may be 10 μm or less, 5 μm or less, 3 μm or less, 2 μm or less, or 1 μm or less. Note that the average particle diameter can be obtained by observing SEM or the like by an electronic microscope, and is obtained, for example, as an average of the largest ferret diameters of the plurality of particles. The number of samples is preferably large, for example, 20 or more, may be 50 or more, or may be 100 or more. The average particle diameter can be appropriately adjusted, for example, by appropriately changing the manufacturing conditions of silicon particles to be described later or by performing a classification process.

The silicon particles included in the surface-modified cathode active material particles may be porous silicon particles. The porous silicon particles include silicon having a plurality of voids. There is no particular limitation on the form of voids in the porous silicon particles.

The porous silicon particles may be particles comprising nanoporous silicon. Nanoporous silicon refers to silicon in which there are a plurality of pores having pore diameters on the order of nanometers (less than 1000 nm, preferably less than or equal to 100 nm).

### Organic Group

The surface-modified cathode active material particles of the present disclosure have an organic group that modifies the surface of the silicon particles.

The organic group may be a group consisting of one or more carbon atoms and one or more atoms selected from the group consisting of H, O, S, N, B, P, Si, and halogen atoms, and is preferably an alkyl group.

The number of carbon atoms of the alkyl group may be 5 or more and 20 or less. The number of carbon atoms may be 6 or more, 19 or less, or 18 or less. The alkyl group may have a linear, branched, or cyclic structure, but is preferably a linear alkyl group. Specific examples of such trialkyl groups include pentyl groups, hexyl groups, heptyl groups, octyl groups, nonyl groups, decyl groups, undecyl groups, dodecyl groups, tridecyl groups, tetradecyl groups, pentadesyl groups, hexadecyl groups, heptadesyl groups, octadecyl groups, nonadesyl groups, and eicosyl groups.

The fact that the alkyl group is modified on the surface of the silicon particles can be confirmed by measuring the amount of carbon and the amount of hydrogen on the surface of the silicon particles after the treatment of the surface with the alkyl group, and analyzing the state of the surface functional group of the particles. As a method for measuring the amount of carbon on the surface, a high-frequency combustion infrared absorption method is exemplified, and as a method for measuring the amount of hydrogen on the surface, an inert gas kidnapping infrared absorption method is exemplified, and as a method for analyzing the state of the surface functional group, a time-of-flight secondary ion-mass spectrometry (TOF-SIMS) is exemplified, but is not limited thereto.

The surface-modified cathode active material particles may have a silicon-carbon bond, silicon may be silicon of the silicon particles, and carbon may be carbon of an alkyl group. That is, the carbon of the alkyl group may be bonded directly to the silicon on the surface of the silicon particle.

### Binder Resin

The cathode active material composite particles of the present disclosure include a binder resin. The binder bonds the plurality of silicon particles to each other. The type of the binder is not particularly limited. For example, it may be selected from butadiene rubber (BR) based binders, butylene rubber (IIR) based binders, acrylic butadiene rubber (ABR) based binders, styrene butadiene rubber (SBR) based binders, polyvinylidene fluoride (PVdF) based binders, polytetrafluoroethylene (PTFE) based binders, polyimide (PI) based binders, carboxymethylcellulose (CMC) based binders, polyacrylate based binders, polyacrylate ester based binders, and the like. Only one binder may be used alone, or two or more binders may be used in combination.

The ratio of the mass of the binder resin contained in the cathode active material composite particles of the present disclosure to the total mass of the surface-modified cathode active material particles and the binder resin is 15% by mass or less. The proportion may be 14% by mass or less, 13% by mass or less, 12% by mass or less, 11% by mass or less, or 10% by mass or less. The cathode active material composite particles of the present disclosure have high cycle characteristics of the obtained battery even when the amount of the binder resin is small.

### Production Method of Cathode Active Material Composite Particles

The method of the present disclosure for producing cathode active material composite particles includes (a) modifying the surface of the silicon particles with an organic group to obtain surface-modified cathode active material particles, (b) dropletizing a slurry containing the surface-modified cathode active material particles, a binder resin, and a solvent to obtain slurry droplets, and (c) air-drying the slurry droplets in a heated gas.

According to this method, for example, even when the composite particles are dried by spray drying in step (c), the dispersibility of the silicon particles in the composite particles is improved, and the binder resin is present in the central portion of the composite particles, so that the silicon particles can be appropriately bound to each other, so that the composite particles of the present disclosure can be produced.

In step (a), the surface of the silicon particle may be modified with an organic group by a hydrosilylation reaction in which an organic group is added to the hydrosilyl group on the surface of the silicon particle. For example, when the organic group is an alkyl group, the hydrosilylation reaction may be performed by mixing hydrotreated silicon particles, alkenes, and optionally a catalyst in a solvent and reacting the mixture.

Examples of a method for obtaining hydrofluoric-treated silicon particles include a method in which a hydrogen fluoride solution is added to silicon particles dispersed in a dispersion medium and stirred, and the obtained suspension is solid-liquid separated and dried. As a result, silicon oxide on the surface of the silicon particles can be removed, and at the same time, hydrosilyl groups (—SiH) can be generated on the surface of the silicon particles.

The hydrosilylation reaction can be performed by the hydrosilyl group and the double bond of the alkene.

For alkenes, the corresponding carbon number alkenes can be used with reference to the above description of the alkyl groups of the present disclosure. Cathode Composite Material

The cathode composite material of the present disclosure includes the cathode active material composite particles of the present disclosure. In addition, the cathode composite material of the present disclosure optionally includes an electrolyte, a conductive auxiliary agent, and a binder.

In the context of the present disclosure, the “cathode composite material” means a composition capable of forming a cathode active material layer as it is or by further containing other components. In addition, in the context of the present disclosure, the “cathode composite material slurry” means a slurry that includes a dispersion medium in addition to the “cathode composite material” and can be applied and dried thereby to form a cathode active material layer.

### Cathode Active Material

The cathode active material includes the cathode active material composite particles of the present disclosure.

### Electrolyte

The material of the solid electrolyte is not particularly limited, and a material that can be used as a solid electrolyte used in a lithium-ion battery can be used. For example, the solid electrolyte may be a sulfide solid electrolyte.

Examples of sulfide solid electrolytes include, but are not limited to, sulfide amorphous solid electrolytes, sulfide crystalline solid electrolytes, or argyrodite solid electrolytes. Specific examples of sulfide solid electrolyte include Li₂S—P₂S₅-based materials (Li₂P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, etc.; or combinations thereof, but are not limited to these.

The sulfide solid electrolyte may be glass or crystallized glass (glass ceramic).

When the cathode composite material contains a solid electrolyte, the mass ratio of the cathode active material composite particles to the solid electrolyte in the cathode composite material (mass of the cathode active material composite particles: mass of the solid electrolyte) is preferably 85:15 to 30:70, and more preferably 80:20 to 40:60.

The electrolyte preferably contains a supporting salt and a solvent.

Examples of the supporting salt of the electrolyte that has lithium-ion conductivity (lithium salt) include: inorganic lithium salts such as LiPF₆, LiBF₄, LiCIO₄, and LiAsF₆; and organic lithium salts such as LiCF₃SO₃, LIN(CF₃SO₂)₂, LIN(C₂F₅SO₂)₂, LIN(FSO₂)₂, and LiC(CF₃SO₂)₃.

Examples of solvents used in the electrolyte include cyclic esters (cyclic carbonates) such as ethylene carbonate (EC), propylene carbonate (PC), and butylene carbonate (BC), and linear esters (linear carbonates) such as dimethyl carbonate (DMC), diethyl carbonate (DEC), and ethyl methyl carbonate (EMC). The electrolytic solution preferably contains two or more solvents.

### Conductive Aid

The conductive aid is not particularly limited. For example, the conductive aid may be, but is not limited to, VGCF (vapor deposited carbon fiber, Vapor Grown Carbon Fiber) and acetylene black (AB), Ketjen black (KB), carbon nanotubes (CNT), carbon nanofibers (CNF), and the like.

### Binder

The binder is not particularly limited. For example, the binder may be a material such as, but not limited to, polyvinylidene fluoride (PVdF), butadiene rubber (BR), or styrene butadiene rubber (SBR), or a combination thereof.

### Lithium-Ion Battery

The lithium-ion battery of the present disclosure includes a cathode active material layer. The cathode active material layer contains the cathode composite material of the present disclosure. The lithium-ion battery of the present disclosure may include a cathode current collector layer, a cathode active material layer containing the cathode composite material of the present disclosure, a solid electrolyte layer, a positive electrode active material layer, and a positive electrode current collector layer in this order.

The lithium-ion battery of the present disclosure may be a liquid-based battery containing an electrolyte solution as an electrolyte layer, or may be a solid-state battery having a solid electrolyte layer as an electrolyte layer. In the context of the present disclosure, a “solid battery” means a battery using at least a solid electrolyte as an electrolyte, and therefore a solid battery may use a combination of a solid electrolyte and a liquid electrolyte as an electrolyte. The solid-state battery of the present disclosure may be an all-solid-state battery, that is, a battery using only a solid electrolyte as an electrolyte.

The lithium-ion battery may be a primary battery or a secondary battery.

The shape of the lithium-ion battery, for example, coin-type, laminate-type, cylindrical, square-type.

### Cathode Current Collector Layer

The material used for the cathode current collector layer is not particularly limited, and a material that can be used as a cathode current collector of a battery may be appropriately employed, and for example, copper, a copper alloy, and a material obtained by plating or depositing nickel, chromium, carbon, and the like on copper may be used, but is not limited thereto.

The shape of the cathode current collector layer is not particularly limited, and may be, for example, a foil shape, a plate shape, or a mesh shape. Among the above, the foil shape is preferred.

### Cathode Active Material Layer

The cathode active material layer contains the cathode composite material of the present disclosure. Regarding the cathode composite material, the above description regarding the cathode composite material of the present disclosure can be referred to.

The thickness of the cathode active material layers is, for example, 0.1 μm to 1000 μm, preferably 1 μm to 100 μm, and more preferably 30 μm to 100 μm.

### Electrolyte Layer

The electrolyte layer contains at least an electrolyte. In addition, the electrolyte layer may contain a binder or the like as necessary in addition to the electrolyte. For the electrolyte and the binder, reference can be made to the above description of the cathode composite material of the present disclosure.

The thickness of the electrolyte layer is, for example, 0.1 to 300 μm, and preferably 0.1 to 100 μm.

### Positive Electrode Active Material Layer

The positive electrode active material layer is a layer containing a positive electrode active material, an optional electrolyte, a conductive auxiliary agent, a binder, and the like.

The material of the positive electrode active material is not particularly limited. For example, the positive electrode active material may be lithium cobalt oxide (LiCoO₂), lithium nickelate (LiNiO₂), lithium manganate (LiMn₂O₄), a heteroelement-substituted Li—Mn spinel having a composition represented by LiCo_{1/3}Ni_{1/3}Mn_{1/3}O₂, Li₁₊ₓMn_{2-x-y}MyO₄ (M is one or more metallic elements selected from Al, Mg, Co, Fe, Ni, and Zn), lithium titanate (LiₓTiO_{y}), lithium metal phosphate (LiMPO₄, M is one or more metals selected from Fe, Mn, Co, and Ni), but is not limited thereto.

The positive electrode active material may have a coating layer. The coating layer is a layer containing a material having lithium-ion conductivity, having low reactivity with a positive electrode active material or a solid electrolyte, and capable of maintaining a form of a coating layer that does not flow even when in contact with an active material or a solid electrolyte. In addition to LiNbO₃, Li₄Ti₅O₁₂, Li₃PO₄ may be exemplified, but is not limited thereto.

Examples of the shape of the positive electrode active material include particles. The mean particle diameter (D50) of the positive electrode active material is not particularly limited, but may be, for example, 10 nm or more and 100 nm or more. Meanwhile, the mean particle diameter (D50) of the positive electrode active material is, for example, 50 μm or less, and may be 20 μm or less. The mean particle diameter (D50) can be calculated, for example, from measurements by means of a laser diffractometer, a scanning-electron-microscope (SEM).

For the electrolyte, the conductive aid, and the binder, reference can be made to the above description of the cathode composite material of the present disclosure.

When the positive electrode active material layer contains a solid electrolyte, the mass ratio of the positive electrode active material to the solid electrolyte in the positive electrode active material layer (mass of the positive electrode active material: mass of the solid electrolyte) is preferably 85:15 to 30:70, and more preferably 80:20 to 50:50.

The thickness of the positive electrode active material layers is, for example, 0.1 μm to 1000 μm, preferably 1 μm to 100 μm, and more preferably 30 μm to 100 μm.

### Positive Electrode Current Collector Layer

The material used for the positive electrode current collector layer is not particularly limited, and a material that can be used as a positive electrode current collector of a battery may be appropriately employed, and for example, a material such as SUS, nickel, chromium, gold, platinum, aluminum, iron, titanium, and zinc, and a material obtained by plating or depositing nickel, chromium, carbon, or the like on these metals may be used, but is not limited thereto.

The shape of the positive electrode current collector layer is not particularly limited, and may be, for example, a foil shape, a plate shape, or a mesh shape. Among the above, the foil shape is preferred.

### Preparation of Surface-Modified Cathode Active Material Particles

### Preparation of Silicon Particles

### Comparative Synthesis Example 1

Silicon particles were prepared as a source of silicon (Si). The silicon particles and metallic lithium (Li) were weighed in a molar ratio of Li/Si=4.0 and the weighed silicon particles and Li were mixed in a mortar in an argonic atmosphere to obtain a lithium silicon (LiSi) alloy. The resulting LiSi alloy was reacted with ethanol in an argon-atmosphere to obtain porous silicon particles.

Porous silicon particles 10 g was dispersed in an ethanol 100 mL. Then, a 3.7 mL of aqueous 46 wt % hydrofluoric acid (HF) was added dropwise, and the mixture was stirred at room temperature for 3 hours. After agitation, the solutions were filtered by aspiration, washed with an ethanolic 50 mL, and filtered 8 times. The resulting solids were vacuum-dried at 100° C. for 12 hours to obtain HF treated porous silicon particles.

### Modification with Alkyl Group

### Synthesis Example 1

In an argon (Ar)-substituted glove box, 10 μL of HF treated porous silicon particle 2 g, mesitylene (manufactured by Nacalai Tesque Co., Ltd.) 30 g, 1-hexene (manufactured by Fujifilm Wako Pure Chemical Industries, Ltd.) 0.18 g, and platinum(0)-1,3-divinyl-1,1,3,3-tetramethyldisiloxane complex xylene solution (manufactured by Sigma-Aldrich) were weighed, placed in a closed reaction vessel, and stirred at 50° C. for 24 hours to react (hydrosilylation reaction). The stirred solutions were filtered by aspiration, washed with mesitylene 30 mL and filtered three times, and then washed once with an ethanolic 30 mL and filtered. The obtained solids were vacuum-dried at 100° C. for 12 hours to prepare surface-modified cathode active material particles in which a part of Si—H bond on the surface of the silicon particles was made of Si—C₆H₁₃, that is, the surface of the silicon particles was modified with a hexyl group (—C₆H₁₃).

### Synthetic Example 2

In the same manner as in Synthesis Example 1, except that the alkene was changed to 1-decene (Fujifilm Wako Pure Chemical Industries) 0.30 g, surface-modified cathode active material particles were prepared in which a part of Si-H bond on the surface of the silicon particles was Si—C₁₀H₂₁, that is, the surface of the silicon particles was modified with a decyl group (—C₁₀H₂₁).

### Synthetic Example 3

A surface-modified cathode active material particle was prepared in the same manner as in Synthesis Example 1 except that the surface-modified cathode active material particle alkene was changed to 1-octadecene (Fujifilm Wako Pure Chemical Industries) 0.55 g, in which a part of Si—H bond on the surface of the silicon particle was Si—C₁₈H₃₇, that is, the surface of the silicon particle was modified with an octadecyl group (—C₁₈H₃₇).

### Preparation of Cathode Active Material Composite Particles

### PVdF-HFP Used as Binder Resin

### Comparative Examples 1 to 3 and Examples 1 to 9

Polyvinylidene fluoride-hexafluoropropylene copolymer (PVDF-HFP) (KF8300 manufactured by Kreha Co., Ltd.) was dissolved in dimethyl carbonate to give 1 wt %. Silicon particles of Comparative Synthesis Example 1 and any of the surface-modified cathode active material particles of Synthesis Examples 1 to 3 were stirred in this solution so as to have silicon particles: PVdF-HFP =94:6, 92:8, and 90:10 by weight, respectively, and then dispersed by a homogenizer, and then spray-dried using this solution spray dryer (ADL311S-A, manufactured by Yamato Scientific Co., Ltd.) to obtain cathode active material composite particles of Comparative Examples 1 to 3 and Examples 1 to 9.

### SBR Used as Binder Resin

### Comparative Example 4 and Example 10

Styrene butadiene (SBR) was dissolved in butyl butyrate to give 1 wt %. Silicon particles of Comparative Synthesis Example 1 and any of the surface-modified cathode active material particles of Synthesis Example 3 were stirred in this solution so as to have a silicon particle: SBR=92:8 by weight, respectively, and then dispersed by a homogenizer, and then spray-dried using this solution spray dryer (manufactured by Yamato Scientific Co., Ltd., ADL311S-A) to obtain cathode active material composite particles of Comparative Example 4 and Example 10.

The relationship between the alkyl group modifying the surface of the obtained cathode active material composite particles, the type of the binder resin, and the amount of the binder resin is as shown in Table 2.

### Preparation of Batteries

### Preparation of Positive Electrode Composite Material

To a polypropylene (PP) container, butyl butyrate, a PVDF based binder in 5 wt % butyl butyrate solution, LiNi_{1/3}Co_{1/3}Mn_{1/3}O₂ (mean particle size: 6 μm) as a positive electrode active material, Li₂S—P₂S₅ based glass-ceramic as a sulfide solid-state electrolyte, and vapor-grown carbon fiber (VGCF) as a conductive auxiliary agent were added to the container, and the mixture was stirred in an ultrasonic dispersing device (UH-50 manufactured by S. M. T.) for 30 seconds. Next, the container was shaken with a shaker (TTM-1, manufactured by Shibata Science Co., Ltd.) for 3 minutes, and stirred with an ultrasonic dispersing device for 30 seconds. Further, the mixture was shaken in a shaker for 3 minutes to obtain a slurry-like positive electrode composite material (positive electrode mixture slurry).

### Formation of Positive Electrode Active Material Layer

The resulting slurry was coated on an aluminium (Al) foil (manufactured by Showa Denko Co., Ltd.) as positive electrode current collector layers by a blade method using an applicator. The coated slurry was dried on a hot plate at 100° C. for 30 minutes. Thus, a positive electrode active material layer was formed on the positive electrode current collector layer.

### Preparation of Cathode Composite Material

To a polypropylene (PP) container, dibutyl ether, mesitylene, SBR based binder 5 wt % mesitylene solutions, VGCF as a conductive auxiliary agent, Li₂S—P₂S₅ glass-ceramics, the cathode active material composite particles of the respective examples were added to the container, and the mixture was stirred for 30 seconds with an ultrasonic dispersing device (UH-50 manufactured by SMT). Further, the container was shaken with a shaker (manufactured by Shibata Science Co., Ltd., TTM-1) for 30 minutes to obtain a slurry-like cathode composite material (cathode composite material slurry).

### Formation of Cathode Active Material Layer

The resulting slurry was applied to a nickel (Ni) foil as a cathode current collector by a blade method using an applicator. The coated slurry was dried on a hot plate at 100° C. for 30 minutes. Thus, a cathode active material layer was formed on the cathode current collector layer.

### Formation of Solid Electrolyte Layer

To a polypropylene (PP) container was added heptane, a SBR based binder in 5 wt % heptane solution, and Li₂S—P₂S₅ glass-ceramic as a solid electrolyte, and the mixture was stirred in an ultrasonic dispersing device (UH-50 manufactured by S.M.T.) for 30 seconds. Further, the container was shaken with a shaker (manufactured by Shibata Science Co., Ltd., TTM-1) for 30 minutes to obtain a solid-electrolyte slurry. The resulting slurry was applied to Al foil by a blade method using an applicator. The coated slurry was dried on a hot plate at 100° C. for 30 minutes. As a result, a solid electrolyte layer was formed. Three solid electrolyte layers were prepared.

### Battery Assembly

The positive electrode current collector layer, the positive electrode active material layer, and the first solid electrolyte layer were laminated in this order. The laminate was set in a roll press and pressed at 165° C. as a press pressure and 100 kN/cm as a press pressure in the first press step to obtain a positive electrode laminate.

The cathode current collector layer, the cathode active material layer, and the second solid electrolyte layer were laminated in this order. The laminate was set in a roll press and pressed at 25° C. as 60 kN/cm and pressing pressure in the second pressing step to obtain a cathode laminate.

The cathode laminate and the positive electrode laminate were prepared so that the area of the cathode laminate was larger than the area of the positive electrode laminate.

Further, a Al foil as a release sheet, an intermediate solid electrolyte layer formed on Al foil, and a cathode laminate were laminated so that the solid electrolyte layers were in contact with each other. The laminate was set in a flat uniaxial press, press-pressure 100 MPa, at a press-temperature of 25° C., was temporarily pressed for 10 seconds. Al foil was peeled from the intermediate solid electrolyte layer of the laminate to obtain a cathode laminate in which the intermediate solid electrolyte layer was further laminated.

The positive electrode laminate and the cathode laminate in which the intermediate solid electrolyte layer was further laminated were laminated so that the solid electrolyte layers were in contact with each other. The laminate was set in a planar uniaxial press and pressed for 1 minute at a pressing pressure 200 MPa and a pressing temperature of 120° C. in a third pressing step. Thus, an all-solid-state battery was obtained.

### Evaluation

### Analysis of Surface Properties of Silicon Particles

Carbon content on the surface of the silicon particles of the synthetic examples and the comparative synthetic examples was measured by a high-frequency burning infrared-absorbing method (used equipment: LECO Co., CSLS600). In addition, the hydrogen content of the silicon particles was measured by an inert gas-melting infrared-ray absorbing method (used equipment: LECO Co., TCH600).

Further, the silicon particles were surface-analyzed by time-of-flight secondary ion-mass spectrometry (TOF-SIMS) (Instrument: ION-TOF Co., TOF.SIMS5, primary ion source: bismuth (Bi)).

### Measurement of Particle Size Distribution of Cathode Active Material Composite Particles

The cathode active material composite particles of each example were dispersed in water and measured by a particle size distribution meter.

### Capacity Retention of Battery

The fabricated batteries were restrained at a predetermined restraining pressure using a restraining tool, charged at a constant current and constant voltage to 4.55 V by 1/10 C, and then discharged to 3.0 V by 1 C. After that, constant current-constant voltage charging was performed up to 4.35 V by 1/3 C, constant current-constant voltage discharging was performed up to 3.00 V by 1/3 C to define the initial capacitance, and then the charge-discharge test was repeated 100 times by 1 C. The capacity retention ratio was calculated by dividing the initial capacity from the capacity after the charge-discharge test was repeated 100 times.

### Results

### Analysis of Surface Properties of Silicon Particles

The results of quantitative analysis of carbon content and hydrogen content on the surface of the silicon particles and the results of TOF-SIMS analysis are shown in

Table 1.

TABLE 1

| | | Elemental content [wt %] | | |
|---|---|---|---|---|
| | Alkyl group | Carbon | Hydrogen | m/z |
| Comparative | — | 0.76 | 0.25 | — |
| Synthesis | | | | |
| Example 1 | | | | |
| Synthesis | —C₆H₁₃ | 1.12 | 0.23 | 85 |
| Example 1 | | | | |
| Synthetic | —C₁₀H₂₁ | 1.16 | 0.24 | 141 |
| Example 2 | | | | |
| Synthetic | —C₁₈H₃₇ | 1.00 | 0.23 | 252 |
| Example 3 | | | | |

As shown in Table 1, in the silicon particles of the synthetic example in which the surface was modified with an alkyl group, the value of the carbon content of the particle surface was larger than that of the silicon particles of the comparative synthetic example. In addition, the higher the number of carbon atoms of the alkyl group, the higher the value of m/z. From these facts, it is considered that the surface of the silicon particles could be modified with an alkyl group.

### Measurement of Particle Size Distribution of Cathode Active Material Composite Particles

The measurement results of particle size distribution measurement of the cathode active material composite particles are shown in Table 2.

### Capacity Retention of The Battery

The calculation results of the capacity retention ratio of the battery are shown in Table 2.

In Table 2, “resin” means a binder resin, and “Si” means silicon particles whose surface is modified in Examples, and silicon particles whose surface is not modified in Comparative Examples.

TABLE 2

| | | | Resin/(Si + | | | | | Capacity |
|---|---|---|---|---|---|---|---|---|
| | Alkyl | | Resin) | Particle size [μm] | | | (D90 − | maintaining |
| | group | Resin | [wt %] | D10 | D50 | D90 | D10)/D50 | rate [%] |
| Comparative | — | PVdF- | 6 | 0.4 | 2.3 | 12.1 | 5.1 | 85 |
| Example 1 | | HFP | | | | | | |
| Example 1 | —C₆H₁₃ | PVdF- | 6 | 1.6 | 4.2 | 9.2 | 1.8 | 90 |
| | | HFP | | | | | | |
| Example 2 | —C₁₀H₂₁ | PVdF- | 6 | 1.8 | 4.6 | 9.9 | 1.8 | 92 |
| | | HFP | | | | | | |
| Example 3 | —C₁₈H₃₇ | PVdF- | 6 | 1.4 | 4.0 | 9.0 | 1.9 | 94 |
| | | HFP | | | | | | |
| Comparative | — | PVdF- | 8 | 0.9 | 3.2 | 13.8 | 4.0 | 83 |
| Example 2 | | HFP | | | | | | |
| Example 4 | —C₆H₁₃ | PVdF- | 8 | 2.1 | 5.1 | 9.9 | 1.5 | 88 |
| | | HFP | | | | | | |
| Example 5 | —C₁₀H₂₁ | PVdF- | 8 | 2.0 | 5.3 | 10.1 | 1.5 | 90 |
| | | HFP | | | | | | |
| Example 6 | —C₁₈H₃₇ | PVdF- | 8 | 2.0 | 5.1 | 9.9 | 1.5 | 90 |
| | | HFP | | | | | | |
| Comparative | — | PVdF- | 10 | 3.5 | 8.1 | 16.4 | 1.6 | 78 |
| Example 3 | | HFP | | | | | | |
| Example 7 | —C₆H₁₃ | PVdF- | 10 | 2.9 | 6.3 | 11.2 | 1.3 | 85 |
| | | HFP | | | | | | |
| Example 8 | —C₁₀H₂₁ | PVdF- | 10 | 2.8 | 6.0 | 11.0 | 1.4 | 87 |
| | | HFP | | | | | | |
| Example 9 | —C₁₈H₃₇ | PVdF- | 10 | 2.4 | 5.8 | 10.6 | 1.4 | 83 |
| | | HFP | | | | | | |
| Comparative | — | SBR | 8 | 3.1 | 10.2 | 15.3 | 1.2 | 79 |
| Example 4 | | | | | | | | |
| Example 10 | —C₁₈H₃₇ | SBR | 8 | 2.5 | 6.2 | 12.1 | 1.5 | 88 |

As shown in Tables 2, the particles of the examples containing the surface-modified silicone particles had a (D90−D10)/D50 of less than or equal to 2.0. From this, it is believed that the particles of the examples are prepared as composite particles. On the other hand, it is considered that the particles of Comparative Examples 1 and 2 were not appropriately adjusted as the composite particles because (D90−D10)/D50 was large.

The batteries containing the particles of Examples 1 to 3 and 4 to 6 had a higher capacity retention ratio, i.e., better cycle characteristics than the batteries of Comparative Examples 1 and 2. This is considered to be because, as described above, in these examples, the composite particles were appropriately prepared even if the amount of the binder resin is small. In particular, the large capacity retention ratio of the batteries of Examples 1 to 3 is considered to be due to the fact that the resistance of the batteries was suppressed because the amount of the binder resin was small.

The batteries containing the particles of Examples 7 to 9 also had a larger capacity retention ratio than the batteries of Comparative Example 3. As described above, even when the amount of the binder resin was relatively large and the particles of the examples and the comparative examples were both presumed to be prepared as composite particles, a difference in the capacity retention ratio occurred. This is considered to be because, in the composite particles of the examples, by surface modification of the alkyl group, aggregation of the silicon particles in the composite particles is suppressed, and an appropriate gap is formed between the silicon particles, so that the volume change when the silicon particles expand during charging and discharging can be relaxed by the gap, and cracking or the like of the composite particles is suppressed.

Furthermore, in the battery of Example 10 in which the type of the binder resin was changed, the capacity retention ratio was larger than that of the corresponding battery of Comparative Example 4.

What is claimed is:

1. Cathode active material composite particles, comprising:
surface-modified cathode active material particles; and a binder resin, wherein
the surface-modified cathode active material particles include silicon particles and an organic group modifying surfaces of the silicon particles, and
a proportion of mass of the binder resin, as to a total mass of the surface-modified cathode active material particles and the binder resin, is 15% by mass or less.

2. The cathode active material composite particles according to claim 1, wherein the organic group is an alkyl group.

3. The cathode active material composite particles according to claim 2, wherein the alkyl group includes no less than five and no more than 20 carbon atoms.

4. The cathode active material composite particles according to claim 2, wherein the surface-modified cathode active material particles include a silicon-carbon bond, the silicon is silicon of the silicon particles, and the carbon is carbon of the alkyl group.

5. A cathode composite material, comprising the cathode active material composite particles according to claim 1.

6. A lithium-ion battery, comprising a cathode active material layer, wherein the cathode active material layer contains the cathode composite material according to claim 5.
